(19) United States
(12) Patent Application Publication
(10) Pub. No.: US 2026/0095277 A1
(43) Pub. Date: Apr. 2, 2026

(54) REDUCED OVERHEAD SIGNALING OF REFERENCES FOR RESOLVING COLLISIONS

(71) Applicant: QUALCOMM Incorporated, San Diego, CA (US)

(72) Inventors: Harikumar KRISHNAMURTHY, San Diego, CA (US); Alberto RICO ALVARINO, San Diego, CA (US); Ayan SENGUPTA, San Diego, CA (US)

(21) Appl. No.: 18/905,048

(22) Filed: Oct. 2, 2024

(51) Int. Cl. H04L 1/1867; H04W 74/0838

(52) U.S. Cl. CPC H04L 1/189; H04W 74/0838

(57) ABSTRACT

Various aspects of the present disclosure generally relate to wireless communication. In some aspects, a user equipment (UE) may receive, from a network node, a transmission configuration associated with a set of transmission occasions comprising two or more transmission occasions that are each associated with a set of resources for contention-based transmissions. The UE may transmit, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message. Numerous other aspects are described.

### FIELD OF THE DISCLOSURE

Aspects of the present disclosure generally relate to wireless communication and specifically relate to techniques, apparatuses, and methods associated with reduced overhead signaling of references for resolving collisions.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to receive, from a network node, a transmission configuration associated with a set of transmission occasions comprising two or more transmission occasions that are each associated with a set of resources for contention-based transmissions. The one or more processors may be configured to transmit, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message.

Some aspects described herein relate to a network node for wireless communication. The network node may include one or more memories and one or more processors coupled to the one or more memories. The one or more processors may be configured to receive, from a UE, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message. The one or more processors may be configured to decode a copy of the message and the reference included with the copy of the message. The one or more processors may be configured to identify a transmission occasion of each remaining copy of the message based on the decoded reference associated with the decoded copy of the message. The one or more processors may be configured to perform successive interference cancellation on the remaining copies of the message based on the decoded copy of the message.

Some aspects described herein relate to a method of wireless communication performed by a UE. The method may include receiving, from a network node, a transmission configuration associated with a set of transmission occasions comprising two or more transmission occasions that are each associated with a set of resources for contention-based transmissions. The method may include transmitting, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message.

Some aspects described herein relate to a method of wireless communication performed by a network node. The method may include receiving, from a UE, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message. The method may include decoding a copy of the message and the reference included with the copy of the message. The method may include identifying a transmission occasion of each remaining copy of the message based on the decoded reference associated with the decoded copy of the message. The method may include performing successive interference cancellation on the remaining copies of the message based on the decoded copy of the message.

Some aspects described herein relate to a non-transitory computer-readable medium that stores a set of instructions for wireless communication by a UE. The set of instructions, when executed by one or more processors of the UE, may cause the UE to receive, from a network node, a transmission configuration associated with a set of transmission occasions comprising two or more transmission occasions that are each associated with a set of resources for contention-based transmissions. The set of instructions, when executed by one or more processors of the UE, may cause the UE to transmit, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message.

Some aspects described herein relate to a non-transitory computer-readable medium that stores a set of instructions for wireless communication by a network node. The set of instructions, when executed by one or more processors of the network node, may cause the network node to receive, from a UE, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message. The set of instructions, when executed by one or more processors of the network node, may cause the network node to decode a copy of the message and the reference included with the copy of the message. The set of instructions, when executed by one or more processors of the network node, may cause the network node to identify a transmission occasion of each remaining copy of the message based on the decoded reference associated with the decoded copy of the message. The set of instructions, when executed by one or more processors of the network node, may cause the network node to perform successive interference cancellation on the remaining copies of the message based on the decoded copy of the message.

Some aspects described herein relate to an apparatus for wireless communication. The apparatus may include means for receiving, from a network node, a transmission configuration associated with a set of transmission occasions comprising two or more transmission occasions that are each associated with a set of resources for contention-based transmissions. The apparatus may include means for transmitting, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message.

Some aspects described herein relate to an apparatus for wireless communication. The apparatus may include means for receiving, from a UE, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message. The apparatus may include means for decoding a copy of the message and the reference included with the copy of the message. The apparatus may include means for identifying a transmission occasion of each remaining copy of the message based on the decoded reference associated with the decoded copy of the message. The apparatus may include means for performing successive interference cancellation on the remaining copies of the message based on the decoded copy of the message.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of diversity slotted ALOHA (DSA) and contention resolution DSA protocols, in accordance with the present disclosure.

FIG. 4 is a diagram illustrating an example associated with reduced overhead signaling of references for resolving collisions, in accordance with the present disclosure.

FIGS. 5A-5B are diagrams illustrating examples associated with reduced overhead signaling of references for resolving collisions, in accordance with the present disclosure.

FIGS. 6-8 are diagrams illustrating examples associated with reduced overhead signaling of references for resolving collisions, in accordance with the present disclosure.

FIG. 9 is a diagram illustrating an example process performed, for example, at a user equipment (UE) or an apparatus of a UE, in accordance with the present disclosure.

FIG. 10 is a diagram illustrating an example process performed, for example, at a network node or an apparatus of a network node, in accordance with the present disclosure.

FIGS. 11-12 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a network node and one or more UEs may support one or more use cases, such as random access or early data transmission (EDT), where collisions may occur when multiple UEs transmit messages (e.g., data packets) to the network node at the same time. For example, in a pure ALOHA protocol, a UE may transmit messages (e.g., data packets) to a network node whenever the UE has data to send and without the need to identify whether any other UE is transmitting at the same time. Because the UEs may transmit messages at random and without coordination in the pure ALOHA protocol, there is a possibility of collisions between UE transmissions that the network node receives at approximately the same time from multiple UEs.

Accordingly, the slotted ALOHA protocol was introduced to enhance the pure ALOHA protocol by enabling the network node to provide the UEs with a synchronized transmission schedule, thereby reducing the probability of collisions (e.g., multiple UEs transmitting in the same slot). In slotted ALOHA, a frame may be divided into multiple time slots of the same length, and each UE may select a time slot in which to transmit. Where multiple UEs select the same time slot to transmit a message, a collision may occur and the network node may be unable to successfully decode the messages involved in the collision.

When a UE determines that a collision has occurred (e.g., when the UE does not receive an acknowledgement from the network node within a time period), the UE may retransmit the message in the next scheduled time slot. For example, in a random access channel (RACH) procedure, where there is a collision between messages transmitted from two different UEs, the network node may perform contention resolution, which may potentially require one or more of the UEs to retransmit their respective messages to the network node. Although slotted ALOHA improves channel utilization via the synchronized scheduling of time slots, slotted ALOHA also increases transmission delays because collisions between UEs may result in one or more message retransmissions. For example, in the context of non-terrestrial network (NTN) deployments or other networks where the time periods for transmitting and receiving messages may be longer relative to terrestrial wireless networks, the increased delay associated with message retransmissions may result in a further reduction in latency performance.

In a diversity slotted ALOHA (DSA) protocol, various diversity techniques are introduced to the principles of slotted ALOHA to improve reliability and throughput. Similar to slotted ALOHA, the DSA protocol divides a frame into multiple time slots of the same length, but DSA also introduces diversity techniques to reduce the impact and probability of interference, fading, and other similar channel problems. For example, the DSA protocol may include spatial diversity (e.g., using multiple antennas), frequency diversity (e.g., transmitting data over multiple frequency channels), and/or time diversity (e.g., repeating transmissions at separate times). By introducing diversity to the slotted ALOHA protocol, the DSA protocol may reduce the probability of collisions where messages are transmitted in multiple, diverse ways. However, where multiple UEs transmit multiple messages at approximately the same time, there remains a possibility that collisions may occur, resulting in increased delays and a further reduction in latency performance.

Accordingly, the contention resolution DSA (CRDSA) protocol enhances the DSA protocol by enabling techniques to resolve message collisions in some cases. In the CRDSA protocol, each transmission from a UE includes multiple copies of a message, where the copies of the message are sent during other transmission occasions within the same transmission occasion group. This transmission of multiple copies of the message enables the network node to resolve message collisions, thereby improving network throughput and reliability and reducing latency by utilizing transmission redundancies and spectrum diversity (e.g., frequency diversity from multiple channels, spatial diversity from multiple antennas, time diversity using repeated transmissions at different time periods, or the like).

For example, when a collision occurs between two messages, the CRDSA protocol enables the network node to perform successive interference cancellation (SIC) with respect to the colliding messages when there is at least one non-colliding message. The network node may decode one of the non-colliding messages and then subtract the reconstructed signal of the decoded message from colliding copies of the message transmitted from the same UE, enabling the network node to subsequently decode the other message in the collision. Accordingly, in the CRDSA protocol, a transmission is successful where at least one of the transmission occasion and resource pairs in which a UE transmits does not collide with a transmission from another UE, or the network node is able to perform SIC for all of the messages that collide with a message in a given transmission occasion and resource pair.

However, where multiple UEs transmit multiple copies of messages in a set of transmission occasion and resource pairs, it may be resource-intensive and inefficient for the network node to search for copies of each non-colliding decoded message in each available transmission occasion and resource pair.

Various aspects relate generally to a contention resolution protocol in which a UE transmits multiple copies of a message in different transmission occasions, with each copy of the message including a reference that enables the network node to identify the transmission occasions and resources in which the other copies of the message were transmitted. Some aspects more specifically relate to the reference indicating a transmission occasion and/or a resource associated with each copy of the message. In some aspects, the reference indicates a transmission occasion and/or a resource associated with a subset of the copies of the message such that the copies of the message and the references form a strongly connected graph. In some aspects, the transmission occasion and resource of a message is selected based on a pseudo random number generator (PRNG) seeded with a value, which is then used as the reference included in each copy of the message such that the network node may utilize the reference as a seed in a PRNG to identify at least one of the transmission occasion or resource of each copy of the message. In some aspects, the value associated with the reference may be a function of a random access occasion group number or a radio frame number associated with the transmission occasion. In some aspects, the value associated with the reference may be based on a hash value of the data within the message, where the network node may hash the data within the received message to obtain the reference and identify the transmission occasion and resource pair associated with the copies of the message. In some aspects, the message may include a seed value associated with the reference and generated based on a hash value of the data within the message, where a PRNG may be seeded with the seed value to select a transmission occasion, and a resource offset may be generated based on the PRNG. In such aspects, the network node may hash the data in the received message, where the hashed value may be used as a seed in a PRNG to identify the transmission occasion of each copy of the message, and a resource offset may be used to identify a resource associated with each copy of the message.

Particular aspects of the subject matter described in this disclosure can be implemented to realize one or more of the following potential advantages. In some examples, the described techniques can be used to increase efficiencies and reduce the overhead in the CRDSA protocol. For example, by including a reference in each copy of a message indicating the transmission occasions of other copies of the message, a network node may efficiently identify the transmission occasion of copies of the message in which to perform SIC (e.g., the transmission occasion and resource pairs of the copies can be identified without searching through every transmission occasion and resource pair). Additionally, by including a reference associated with a subset of the message copies, the signaling overhead associated with the reference may be reduced, relative to signaling a reference to every other copy of the message. Additionally, by including a seed value or a hash value associated with the reference in the message, the network node may identify the transmission occasions of every other copy of the message by computing the transmission occasion using a PRNG seeded with the seed value or with the hash value. This may reduce signaling overhead where the reference includes a single value, and accordingly, fewer bits are needed to identify the message copies. Additionally, by including a seed value or a hash value associated with the reference in the message, the data in all copies of the message may be identical, resulting in less processing overhead in encoding and transmitting copies of the message relative to a protocol in which each copy of the message includes different data.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, NTN deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

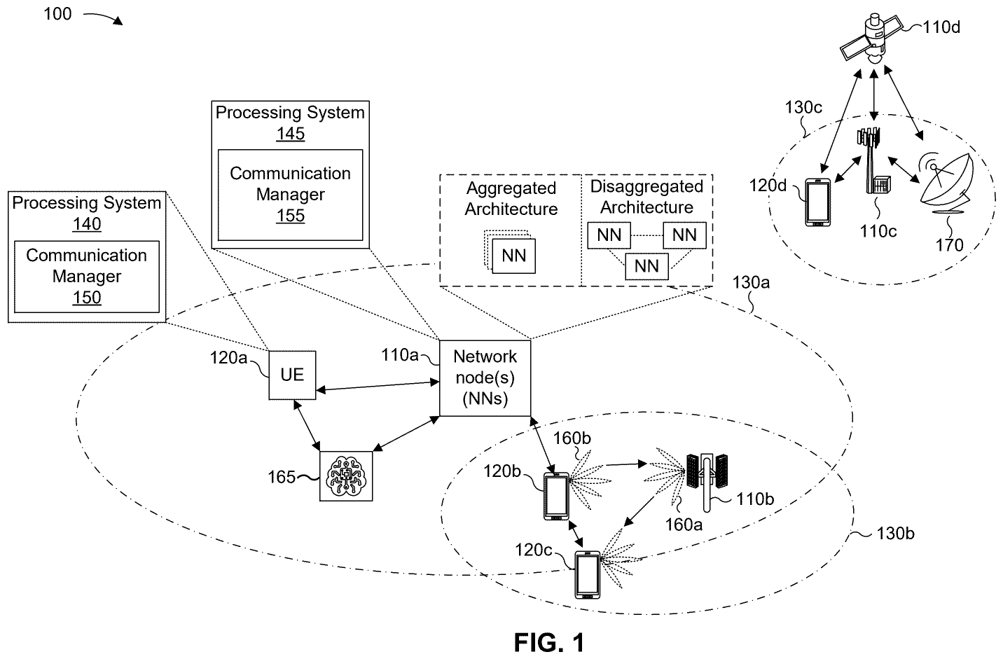

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally, or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles.

Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally, or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples.

As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

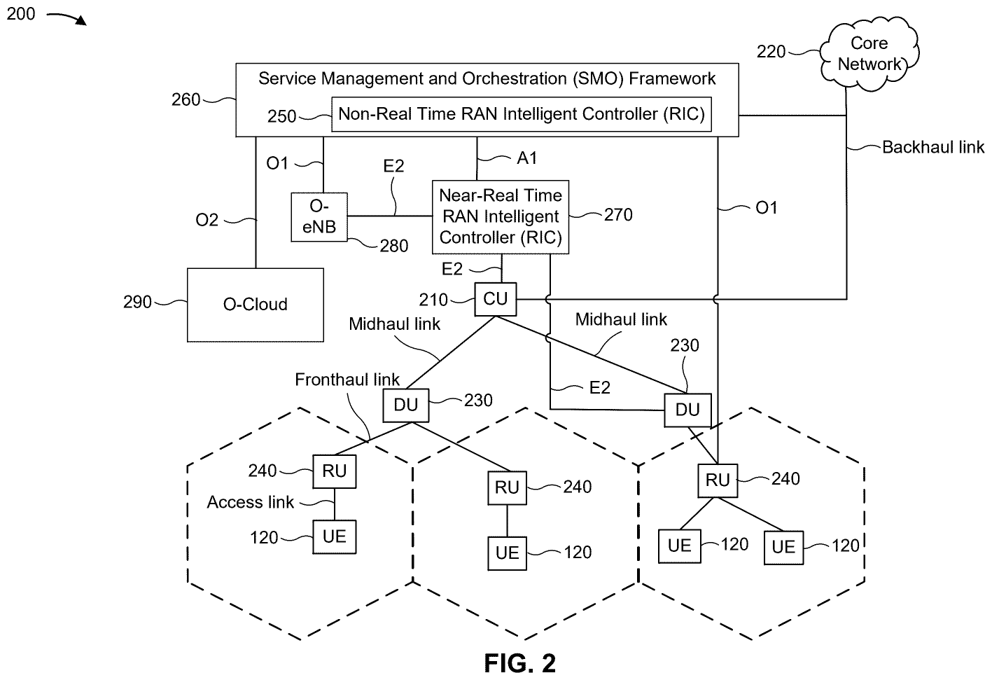

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

As indicated above, a network node 110 may be a terrestrial network node 110 (for example, a terrestrial base station or entity of a disaggregated base station) or an NTN network node 110. In the example shown in FIG. 1, the network node 110c may be an NTN network node 110 and the cell 130c may be an NTN cell. For example, the wireless communication network 100 may include one or more NTN deployments including an NTN network node 110 and/or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. Because of the potentially long distances over which communications may travel in an NTN application and the resulting increase in round trip time (RTT), retransmission of messages (e.g., as part of a contention resolution procedure) following collisions at a network node 110 may result in increased latency. Additionally, other networks that include long propagation delays (e.g., long RTTs) may experience similar increases in latency where messages are retransmitted as part of a contention resolution procedure.

An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless communication network 100 using NTN communication. The other entities may include UEs 120 (for example, the UE 120d, other NTN network nodes 110 in the one or more NTN deployments, other types of network nodes 110 (for example, stationary, terrestrial, and/or ground-based network nodes, such as the network node 110c), relay stations, and/or one or more components and/or devices included in or coupled with a core network of the wireless communication network 100. For example, an NTN network node 110 may communicate with a UE 120 via a service link (for example, where the service link includes an access link). Additionally, or alternatively, an NTN network node 110 may communicate with a gateway 170 (for example, a terrestrial node providing connectivity for the NTN network node 110 to a data network or a core network) via a feeder link (for example, where the feeder link is associated with an N2 or an N3 interface). Additionally, or alternatively, NTN network nodes 110 may communicate directly with one another via an inter-satellite link (ISL). In some examples, an NTN deployment may be transparent (for example, where the NTN network node 110 operates in a similar manner as a repeater or relay and/or where an access link does not terminate at the NTN network node 110). In some other examples, an NTN deployment may be regenerative. For example, an access link may terminate at the NTN network node 110, and the NTN network node 110 may regenerate a signal (such as by performing signal processing or enhancement, which may include error correction, modulation or demodulation, or amplification).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120.

The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, from a network node 110, a transmission configuration associated with a set of transmission occasions; and transmit, to the network node 110, a message in a transmission occasion selected from the set of transmission occasions, wherein the message includes a reference associated with a set of copies of the message. Additionally, or alternatively, the communication manager 150 may perform one or more other operations described herein.

In some aspects, the network node 110 may include a communication manager 155. As described in more detail elsewhere herein, the communication manager 155 may receive, from a UE 120, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message; decode a copy of the message and the reference included with the copy of the message; identify a transmission occasion of each remaining copy of the message based on the decoded reference associated with the decoded copy of the message; and perform successive interference cancellation on the remaining copies of the message based on the decoded copy of the message. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

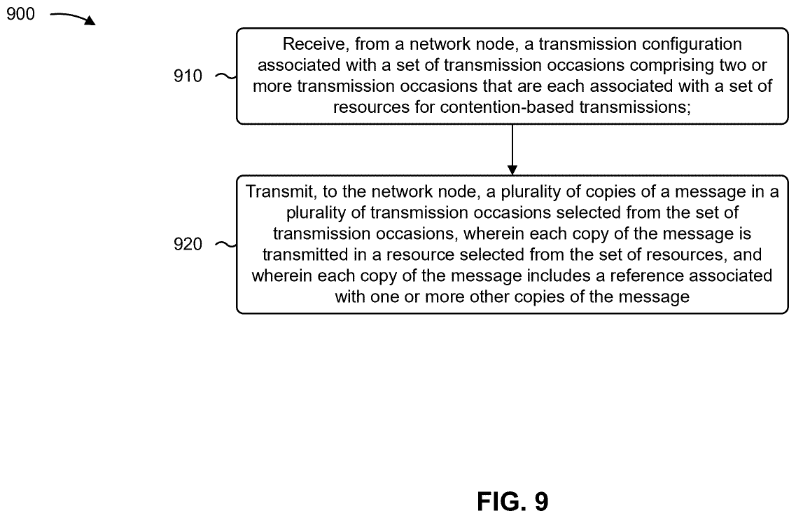

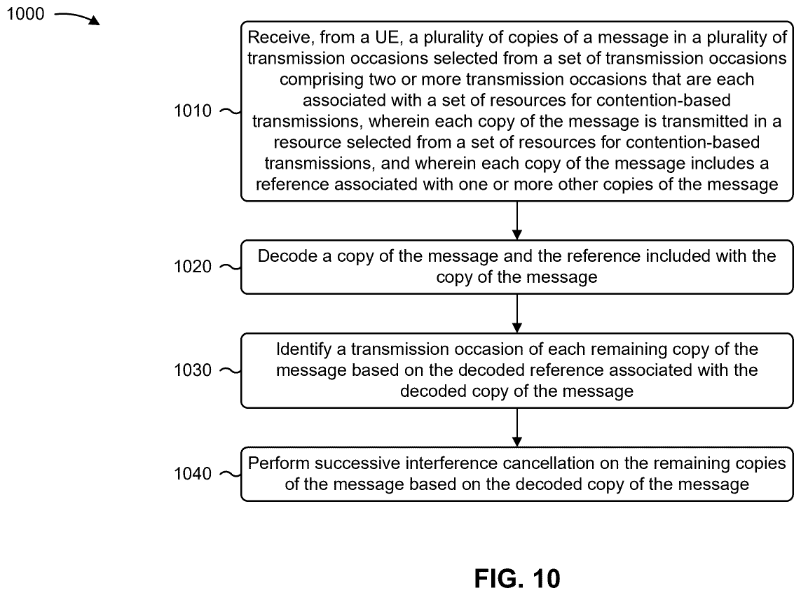

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with reduced overhead signaling of references for resolving collisions in messages, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

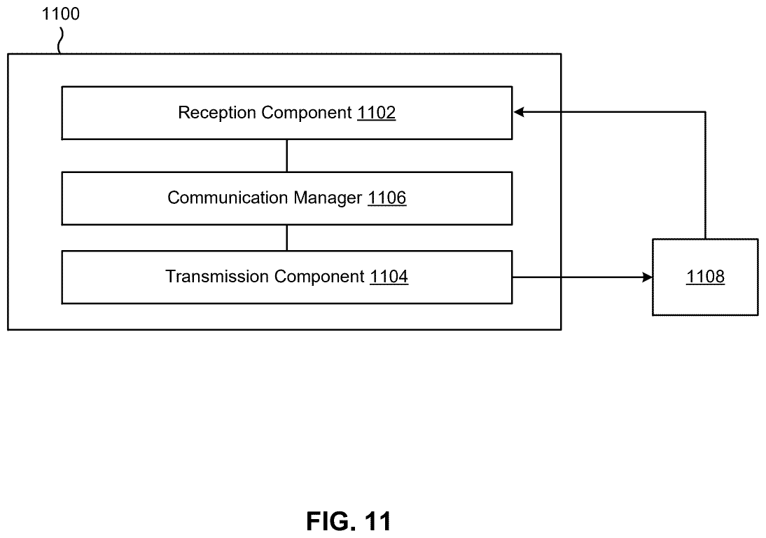

In some aspects, the UE 120 includes means for receiving, from a network node 110, a transmission configuration associated with a set of transmission occasions; and/or means for transmitting, to the network node 110, a message in a transmission occasion selected from the set of transmission occasions, wherein the message includes a reference associated with a set of copies of the message. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11) and/or a transmission component (for example, transmission component 1104 depicted and described in connection with FIG. 11), among other examples.

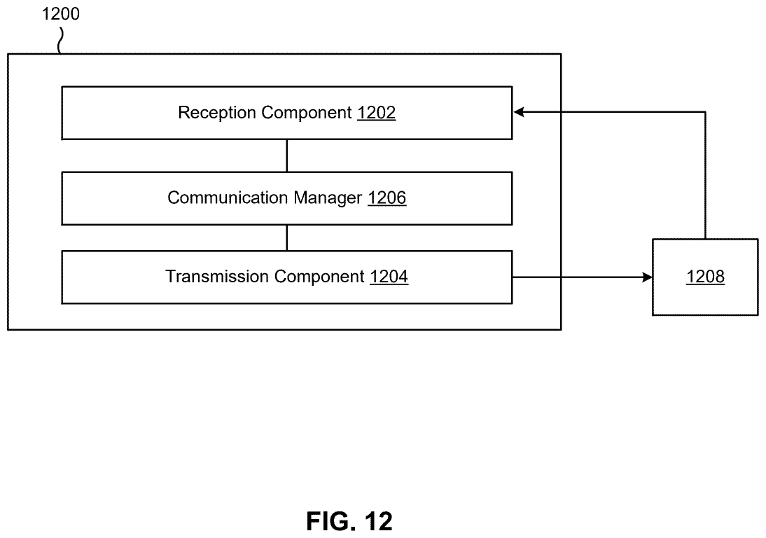

In some aspects, the network node 110 includes means for receiving, from a UE 120, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message; means for decoding a copy of the message and the reference included with the copy of the message; means for identifying a transmission occasion of each remaining copy of the message based on the decoded reference associated with the decoded copy of the message; and/or means for performing SIC on the remaining copies of the message based on the decoded copy of the message. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

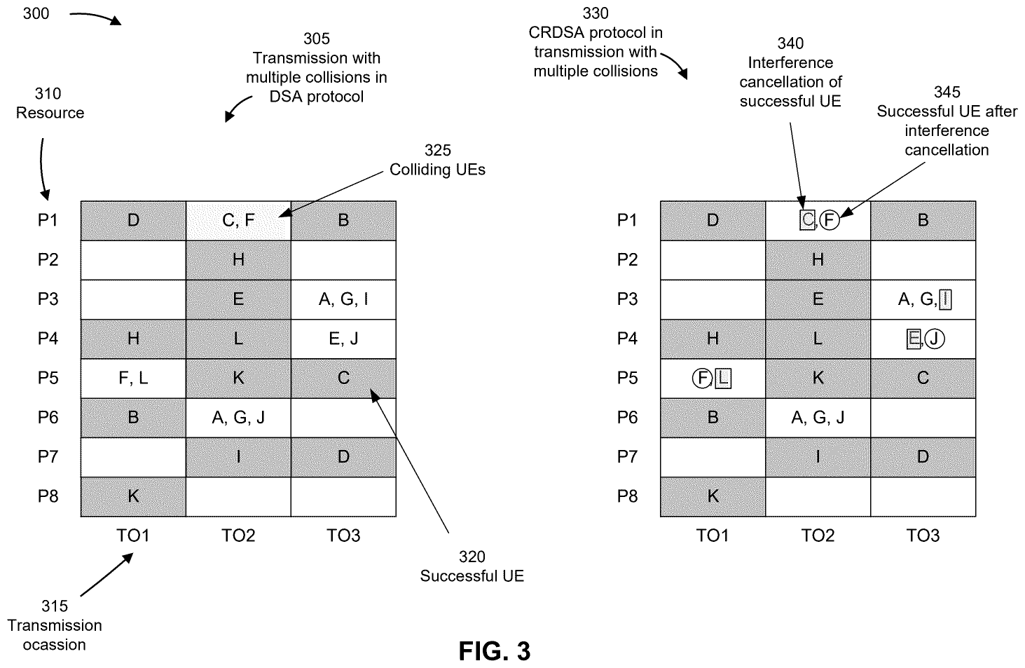

FIG. 3 is a diagram illustrating an example 300 of DSA and CRDSA protocols, in accordance with the present disclosure.

As shown by reference number 305, in a DSA protocol, a network node may configure multiple transmission occasions 315 (e.g., RACH preamble occasions, RACH-less EDT data transmission occasions, or the like) into a transmission occasion group and a UE may choose a set of transmission occasions 315 in which to transmit a message to the network node. In each of the transmission occasions 315, the UE may select a resource 310 (e.g., a preamble, a sequence, and/or another suitable data resource) from a set of available resources 310 in which to transmit. In some aspects, the UE may select the resource 310 in each transmission occasion 315 randomly and/or independently of other resources 310 selected by the UE in other transmission occasions 315.

For example, a network node may configure a transmission occasion group as including N transmission occasions 315 and a UE may choose k transmission occasions 315 of the N transmission occasions 315 in which to transmit. In some aspects, N and k are positive integers, and k is a quantity less than or equal to N. In each of the k transmission occasions 315 selected by the UE, the UE selects a resource 310 from 1 available resources 310.

As shown by reference number 305, the network node may configure a transmission occasion group with N=3, where the transmission occasion group includes three transmission occasions 315 identified as TO1, TO2, and TO3. Additionally, the network node may assign a burst size of k=2, where the UE may select two out of the three transmission occasions 315 in the transmission occasion group and choose a resource 310 in each of the selected transmission occasions 315 in which to transmit a message. For example, the network node may configure eight available resources 310, identified as P1 through P8, in each of the transmission occasions 315 identified as TO1, TO2, and TO3. Additionally, the network node may configure the transmission occasion group and/or the burst size based on network traffic or similar parameters. As shown by reference number 305, the wireless network may include at least twelve UEs (identified as UEs A through L), where the network node has configured the transmission occasion group to serve at least that quantity of UEs.

For example, in a DSA protocol, a UE transmission is successful (e.g., avoids a collision) if at least one transmission occasion 315 and resource 310 pair in which a UE transmits does not collide with a transmission from a separate UE. As shown by reference number 305, the successful UEs 320 may be identified as B, C, D, E, H, I, K, and L.

Additionally, UEs C, E, and I are each involved in only one non-colliding transmission out of the two transmissions from each respective UE. For example, UEs C and F are colliding UEs 325 where both UEs transmitted in resource P1 and transmission occasion TO2.

In a CRDSA protocol, once the network node successfully decodes one copy of a message in a burst received from the UE, the network node may cancel the interference from the other copies of the message in the burst to enable decoding of messages from other UEs that transmitted colliding messages in the same resource 310 and transmission occasion 315 pair. In some respects, this process of interference cancellation followed by additional decoding may be repeated multiple times, for example, where the messages of more than two UEs collide at the same resource 310 and transmission occasion 315 pair.

As shown by reference number 330, a CRDSA protocol may enable a network node to cancel the interference (e.g., via SIC or another suitable techniques) of UE messages that were successfully decoded. For example, where messages of UEs C, E, I, and L were successfully decoded (e.g., based on transmitting respective non-colliding messages in transmission occasion TO3 and resource P5, transmission occasion TO2 and resource P3, transmission occasion TO2 and resource P7, and transmission occasion TO2 and resource P4), the network node may cancel the interference from the colliding messages transmitted by these UEs. As shown by reference number 340, the network node may use the successful decoding of a non-colliding copy of a message from UE C to cancel the interference from the colliding copy of the message from UE C, and the network node may subsequently decode the message of UE F that collided with the message of UE C in transmission occasion TO2 and resource P1. Accordingly, and as shown by reference number 345, after a first step of interference cancellation of additional copies of the messages of successful UEs, messages from UEs F and J may be decoded.

Where multiple UEs transmit in the same transmission occasion 315 and resource 310, a network node and one or more UEs may perform contention resolution to resolve the collision and decode each of the messages involved in the collision. The contention resolution process may delay the process by which the network node responds to the message from the UE, thereby increasing the latency in a wireless network and increasing the network traffic resulting from the potential retransmission of messages from multiple UEs involved in a collision. For example, the network node may search through each transmission occasion and resource pair to identify the colliding copies of a decoded message, resulting in a resource intensive and inefficient process. By including a reference associated with a set of copies of a message in each copy of a message, the network node may identify colliding copies of a decoded (non-colliding) message and remove interference due to other copies of the message more efficiently, relative to searching each transmission occasion and resource pair for the copies of the message.

As indicated above, FIG. 3 is provided as an example. Other examples may differ from what is described with respect to FIG. 3.

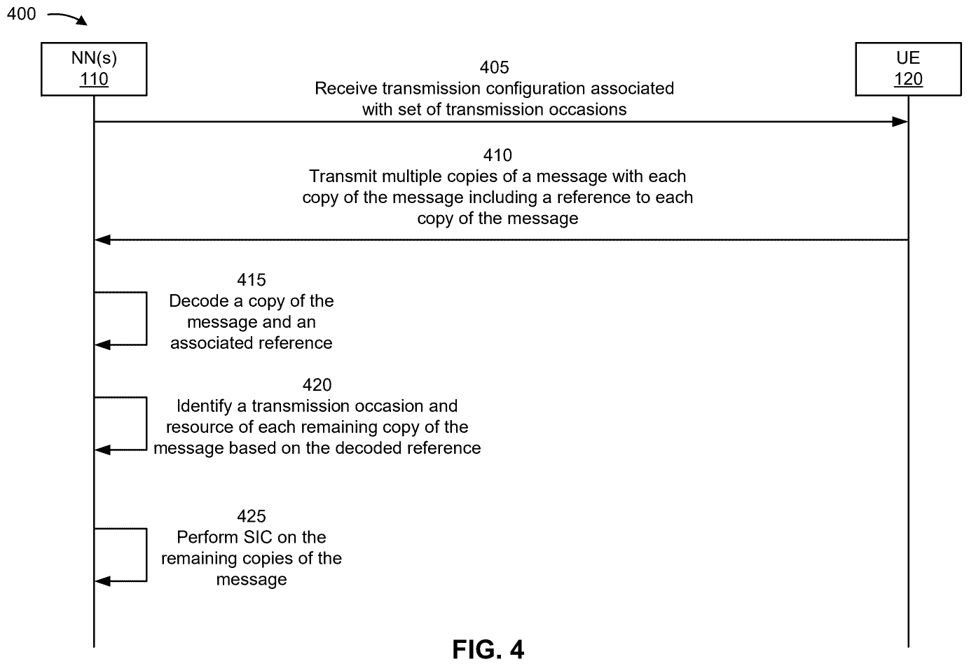

FIG. 4 is a diagram illustrating an example 400 associated with reduced overhead signaling of references for resolving collisions, in accordance with the present disclosure. As shown in FIG. 4, example 400 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown by reference number 405, the UE 120 may receive, from the network node 110, a transmission configuration associated with a set of transmission occasions. In some aspects, the set of transmission occasions may include a plurality of transmission occasions associated with a plurality of respective resources. In some aspects, the UE 120 may be configured to select k transmission occasions from the N transmission occasions of the set of transmission occasions.

As shown by reference number 410, the UE 120 may transmit multiple copies of a message, with each copy of the message including a reference to each other copy of the message. In some aspects, the reference may include an indication of the transmission occasions and/or resources of other copies of the message transmitted from the UE 120. For example, where the network node 110 configures a transmission occasion group to include two transmission occasions, a burst size to be two copies of a message, and a number of available resources to be forty-eight, the UE 120 may only include the resource number in the reference, because the transmission occasion of the other copy of the message is known. In such an example, the indication of the resource number included in the reference can be encoded in [log₂ 48] bits, or six bits. More generally, when the reference indicates only the resource number, the reference can be encoded in [log₂l] bits, where l is the number of available resources. However, as the number of transmission occasions and the burst size increases, the data size may increase and result in a larger data transmission overhead. Additionally, where k<N (e.g., where the UE 120 is configured to select fewer transmission occasions than are present in the transmission occasion group), the reference may indicate the resource and the transmission occasion, because the transmission occasions of other copies are not known, thus further increasing the signaling overhead.

As shown by reference number 415, after receiving the set of copies of the message from the UE 120, the network node 110 may decode a copy of the message and the reference associated with the message. As shown by reference number 420, the network node 110 may identify a transmission occasion and/or resource of each remaining copy of the message. As shown by reference number 425, the network node 110 may perform SIC on the remaining copies of the message that were identified. Accordingly, the network node 110 may remove interference due to the other copies of the message, thereby enabling the decoding of messages from additional UEs 120 that may have collided with the decoded message. In some aspects, the reference may include an indication of the transmission occasions and/or resources for all other copies of the decoded message, and the network node 110 may use the indicated transmission occasions and/or resources to inform the performance of SIC on the remaining copies of the message.

As described herein, by including a reference in each copy of a message, the network 110 node may remove interference due to other copies of the message by identifying the transmission occasion and/or resource associated with the other copies of the message. Additionally, where the reference includes an indication of the transmission occasions and/or resources for all other copies of the message decoded by the network node 110, the network node 110 may be able to identify and perform SIC on the remaining copies of the message.

As indicated above, FIG. 4 is provided as an example. Other examples may differ from what is described with respect to FIG. 4.

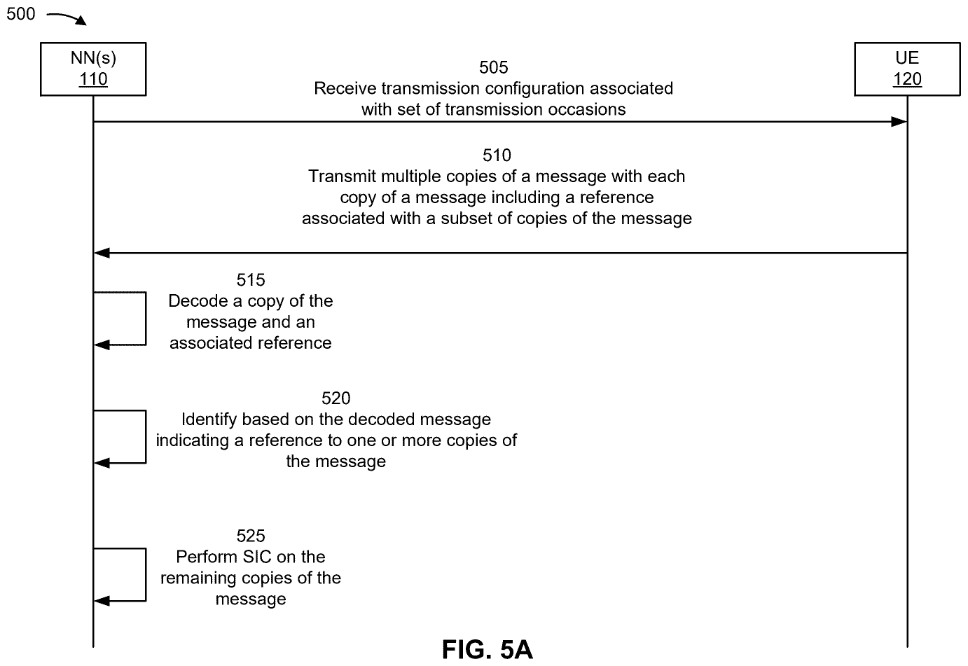

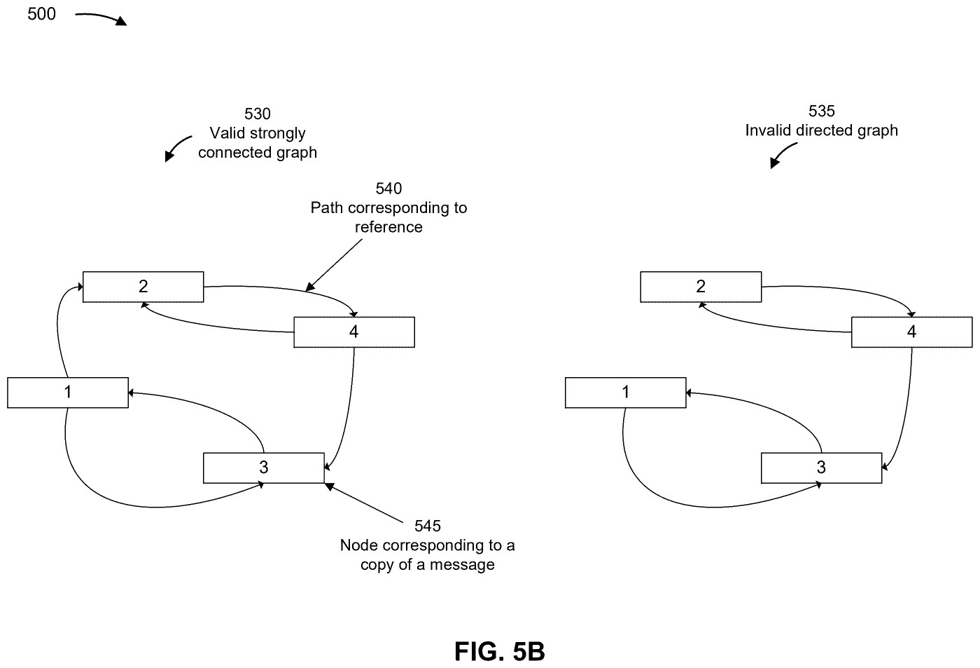

FIGS. 5A-5B are diagrams illustrating examples 500 associated with reduced overhead signaling of references for resolving collisions, in accordance with the present disclosure.

For example, FIG. 5A illustrates an example of a protocol for identifying and resolving colliding copies of a message via references with reduced signaling overhead. As shown by reference number 505, the UE 120 may receive, from the network node 110, a transmission configuration associated with a set of transmission occasions. In some aspects, the set of transmission occasions may include a plurality of transmission occasions associated with a plurality of respective resources. In some aspects, the UE 120 may be configured to select k transmission occasions from the N transmission occasions of the set of transmission occasions.

As shown by reference number 510, the UE 120 may transmit multiple copies of a message, with each copy of the message including a reference associated with a subset of the message copies. In some aspects, the reference may include an indication of the transmission occasions and/or resources of other copies of the message transmitted from the UE 120. In some aspects, the references included in the message copies are configured such that there is a path to every copy of the message, starting at any copy of the message.

As shown by reference number 515, after receiving the set of copies of the message from the UE 120, the network node 110 may decode a non-colliding copy of the message and the reference associated with the message. As shown by reference number 520, the network node 110 may identify a transmission occasion and/or resource pair of each remaining copy of the message based on the reference(s) included in the decoded message and a strongly connected graph that includes a set of nodes to represent the various message copies and edges to represent the reference(s) included in each message copy. For example, the network node 110 may use this configuration to identify a transmission occasion and/or resource pair of each remaining copy of the message based on the strongly connected graph providing a path to every copy of the message, starting from any given copy of the message (e.g., a directed graph having the message copies as nodes and the references as edges forms a strongly connected graph, where any node can be reached from any other node by following the direction of the edges). In some aspects, after the network node 110 identifies a transmission occasion and/or resource of each remaining copy of the message, the network node 110 may proceed with decoding the set of copies of the message from the UE 120, as shown by reference number 515, until no new copies remain for decoding.

As shown by reference number 525, the network node 110 may perform SIC on the remaining copies of the message. Accordingly, the network node 110 may remove interference due to the other copies of the message, thereby enabling the decoding of messages from additional UEs 120 that may have collided with the decoded message.

For example, FIG. 5B illustrates an example of a valid strongly connected graph representing the message copies and the references included in the message copies, which may be used by a network node 110 to identify the transmission occasion and resource pairs of copies of a message and an example of an invalid directed graph.

As shown by reference number 530, a strongly connected graph includes a path 540 from every copy of the message to every other copy of the message where the strongly connected graph includes a directed graph whose nodes are message copies and whose edges are the references associated with the copies of the message 545. For example, the four messages shown as messages 1-4 may be identified based on the availability of a path 540 in which every copy of the message is reachable no matter which copy of the message is at a start of the path 540. For example, after the network node 110 decodes message 1, the network node 110 may identify message 2 and message 3 (e.g., identify the transmission occasions and/or resources) for decoding by following the edge from message 1 to message 3 and the edge from message 1 to message 2, where the edges correspond to the reference included in message 1. After decoding message 2, the network node may identify message 4 for decoding by following the edge from message 2 to message 4, where the edge corresponds to the reference included in message 2.

As shown by reference number 535, in an invalid directed graph, the graph does not include a path from every copy of the message to every other copy of the message. For example, in a scenario where the network node 110 decodes message 1 first, the network node 110 may identify message 3 (e.g., identify the transmission occasion and/or resource) based on message 1 containing a reference to message 3, but the network node cannot identify all other copies of the message after decoding message 3 because message 3 only includes a reference (e.g., path) to message 1 and message 1 only includes a reference to message 3. As a result, message 2 and message 4 may not be decoded if the path starts from message 1 or message 3 (e.g., where message 1 or message 3 is decoded first). Accordingly, in an invalid (not strongly connected) graph, the network node 110 may be unable to efficiently and completely perform SIC with respect to all copies of a decoded message, depending on which message copy is decoded first.

As described herein, by including a reference with each copy of a transmitted message that is associated with a subset of copies of the message, the network node 110 may perform interference cancellation with a reduced overhead. For example, because the transmitted message includes a reference to only a subset of the copies of the message, the data size of the message may be smaller, relative to a message including a reference that indicates the transmission occasions and/or resources for all other copies of the message. For example, there may be minimal overhead when each message copy includes a reference to only one other message copy (e.g., where N=k and l=48, each copy may transmit only 6 bits of data compared to approximately 6(N−1) bits of data when including references to all other copies).

As indicated above, FIGS. 5A-5B are provided as examples. Other examples may differ from what is described with respect to FIGS. 5A-5B.

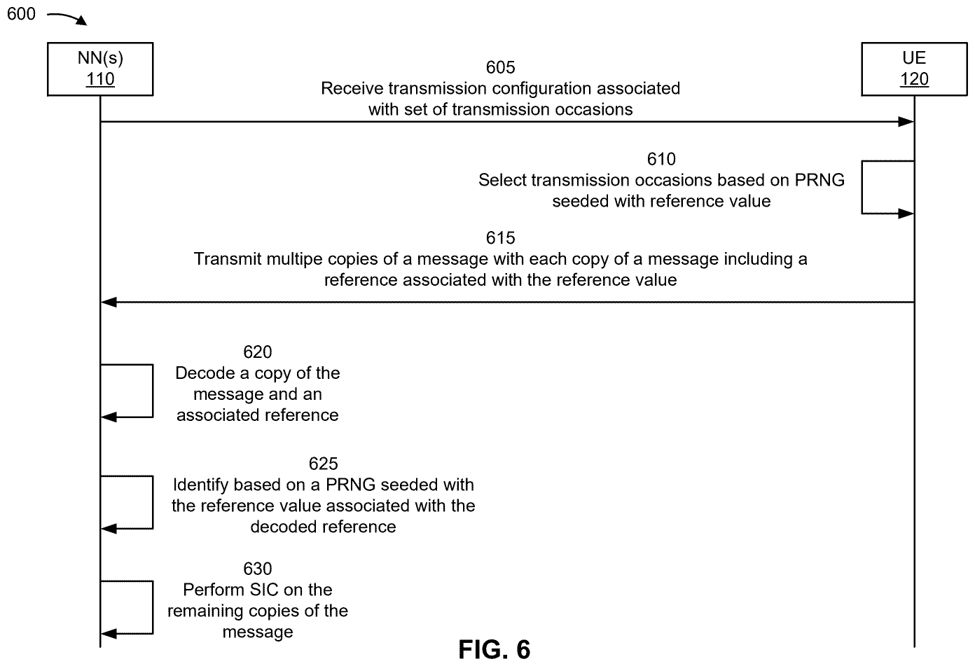

FIG. 6 is a diagram illustrating an example 600 associated with reduced overhead signaling of references for resolving collisions, in accordance with the present disclosure.

As shown by reference number 605, the UE 120 may receive, from the network node 110, a transmission configuration associated with a set of transmission occasions. In some aspects, the set of transmission occasions may include a plurality of transmission occasions associated with a plurality of respective resources. In some aspects, the UE 120 may be configured to select k transmission occasions from the N transmission occasions of the set of transmission occasions.

As shown by reference number 610, the UE 120 may select a reference value that is included within the data of each copy of a message transmitted to the network node 110. The UE 120 may use the reference value as a seed in a PRNG, where the PRNG is used to select the transmission occasions and/or resources in which the UE 120 will transmit. In some aspects, the UE 120 may randomly select the reference value. In some aspects, the reference value may have a length that satisfies (e.g., equals or exceeds) a threshold, to reduce a probability that multiple UEs will select the same reference value. In some aspects, the reference value used as the seed for the PRNG may be a function of a random access occasion group number or a radio frame number in which the message copies are transmitted, in order to prevent the UE 120 from selecting the same transmission occasions and resources in the event of a retransmission following a collision (e.g., an unresolvable collision) between UEs 120. In some aspects, the selected resource includes at least one of a time resource, a frequency resource, an orthogonal cover code associated with the transmission. As shown by reference number 615, the UE 120 may transmit multiple copies of a message with each copy of the message including a reference associated with the reference value.

As shown by reference number 620, after receiving of the set of copies of the message from the UE 120, the network node 110 may decode a copy of the message and the reference associated with the message. As shown by reference number 625, the network node 110 may identify a transmission occasion and/or resource of each remaining copy of the message. For example, by decoding the copy of the message and the associated reference, the network node 110 may obtain the reference value used by the UE 120 to identify the transmission occasions and resources in which the UE 120 transmitted the set of copies of the message. In some aspects, the network node may use the reference value as a seed in a PRNG to identify the transmission occasions and/or resources that the UE 120 selected for transmitting the set of copies of the message.

As shown by reference number 630, the network node 110 may perform SIC on the remaining copies of the message. Accordingly, the network node 110 may remove interference due to the other copies of the message, thereby enabling the decoding of messages from additional UEs 120 that may have collided with the decoded message.

As described herein, by including a reference value associated with a reference included in each copy of a message transmitted to the network node 110, the transmission overhead (e.g., transmission data size and/or other similar parameters) may be reduced. Additionally, because the data in all copies of the message are identical, the UE 120 may use less processing overhead in encoding and transmitting the copies of the message relative to a protocol in which each copy of the message includes different data.

As indicated above, FIG. 6 is provided as an example. Other examples may differ from what is described with respect to FIG. 6.

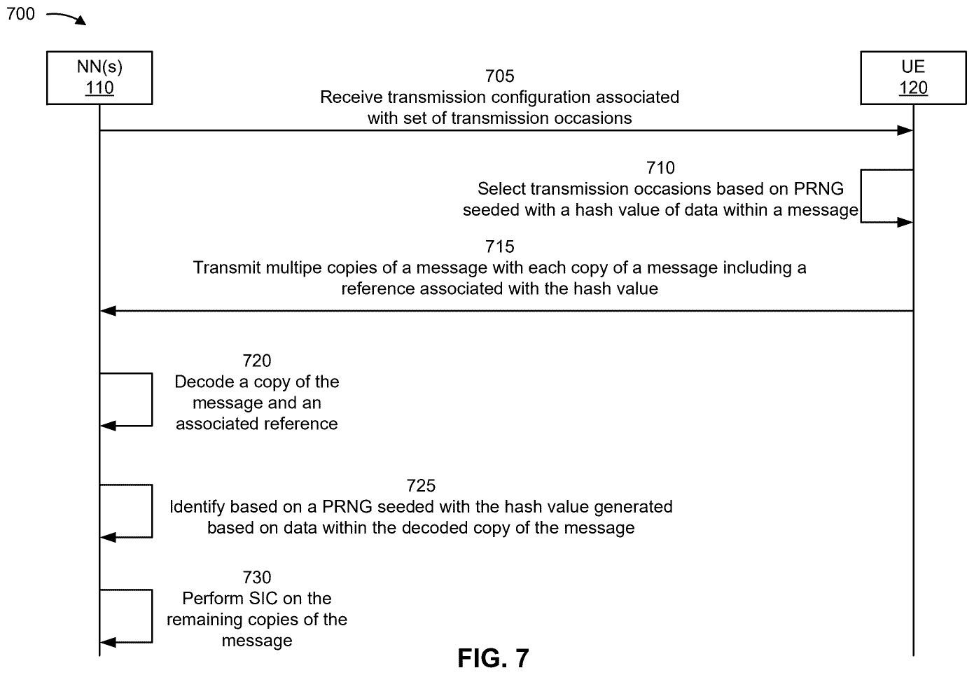

FIG. 7 is a diagram illustrating an example 700 associated with reduced overhead signaling of references for resolving collisions, in accordance with the present disclosure.

As shown by reference number 705, the UE 120 may receive, from the network node 110, a transmission configuration associated with a set of transmission occasions. In some aspects, the set of transmission occasions may include a plurality of transmission occasions associated with a plurality of respective resources. In some aspects, the UE 120 may be configured to select k transmission occasions from the N transmission occasions of the set of transmission occasions.

As shown by reference number 710, the UE 120 may hash the data within a message that is to be transmitted to the network node 110 to obtain a hash value of the data within the message. The UE 120 may use the hash value as a seed in a PRNG, where the PRNG is used to select the transmission occasions and/or resources in which the UE 120 will transmit. In some aspects, the reference value used as the seed for the PRNG may be a function of a random access occasion group number or radio frame number in which the message copies are transmitted, in order to prevent the UE 120 from selecting the same transmission occasions and resources where the UE retransmits the set of copies of the message following a collision (e.g., an unresolvable collision). As shown by reference number 715, the UE 120 may transmit multiple copies of a message, with each copy of the message including a reference associated with the hash value.

As shown by reference number 720, after receiving of the set of copies of the message from the UE 120, the network node 110 may decode a copy of the message and the reference associated with the message. As shown by reference number 725, the network node 110 may identify a transmission occasion of each remaining copy of the message. For example, by decoding the copy of the message and the associated reference, the network node 110 may obtain the hash value used by the UE 120 to hash the data within the decoded message and identify the transmission occasions and/or resources in which the UE 120 transmitted the set of copies of the message. In some aspects, the network node may use the reference value as a seed in a PRNG to identify the transmission occasions and resources that the UE 120 selected for transmitting the set of copies of the message. In some other aspects, the decoded copy of the message may not include a hash value, and the network node 110 may independently hash the data within the decoded message to obtain a hash value to identify (e.g., by using the hash value as a seed in a PRNG) the transmission occasions and/or resources in which the UE 120 transmitted the set of copies of the message. In some aspects, only the resources may be identified by the PRNG seeded with the hash value, and the transmission occasions may be signaled by each copy of the message including a reference indicating the transmission occasions of every other copy of the message or one or more copies of the message such that the copies and the references form a strongly connected graph. Alternatively, in some aspects, only the transmission occasions may be identified by the PRNG seeded with the hash value, and the resources may be signaled by each copy of the message including a reference indicating the resource of every other copy of the message or one or more copies of the message such that the copies and the references form a strongly connected graph.

As shown by reference number 730, the network node 110 may perform SIC on the remaining copies of the message that were identified. Accordingly, the network node 110 may remove interference due to the other copies of the message, thereby enabling the decoding of messages from additional UEs 120 that may have collided with the decoded message.

As described herein, by hashing the data in a copy of the message, the network node 110 may obtain a hash value that may be used to identify the occasions and resources in which the UE 120 transmitted the set of copies of the message. As a result, the transmission overhead (e.g., transmission data size and/or other similar parameters) may be reduced. Additionally, because the data in all copies of the message are identical, the UE 120 may use less processing overhead in encoding and transmitting the copies of the message relative to a protocol in which each copy of the message includes different data. Additionally, the hash of the data may be sufficiently long to reduce a probability that multiple UEs 120 may generate the same hash value, which would otherwise lead to a potential collision.

As indicated above, FIG. 7 is provided as an example. Other examples may differ from what is described with respect to FIG. 7.

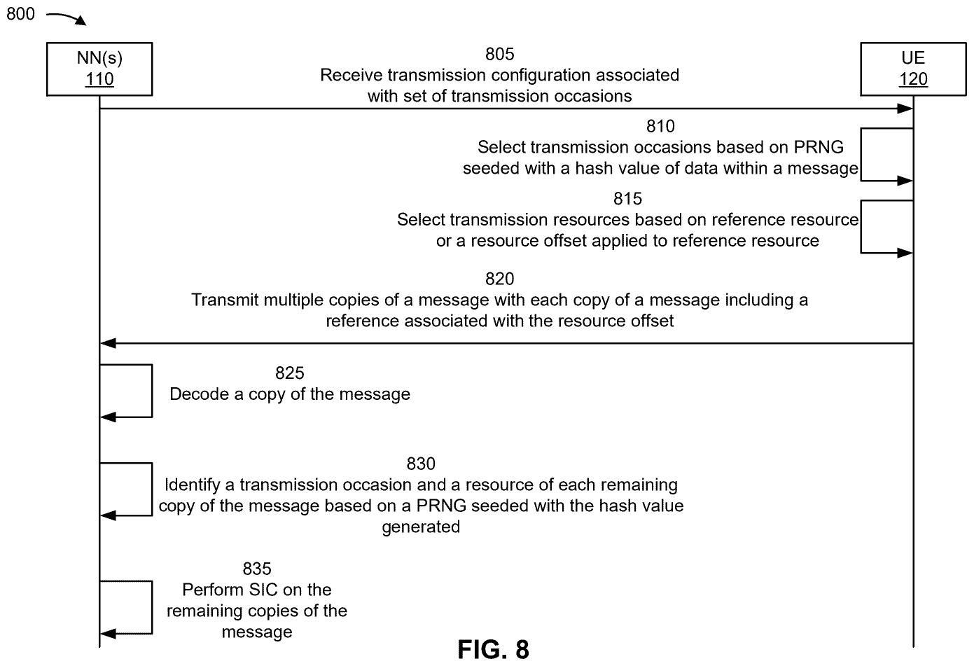

FIG. 8 is a diagram illustrating an example 800 associated with reduced overhead signaling of references for resolving collisions, in accordance with the present disclosure.

As shown by reference number 805, the UE 120 may receive, from the network node 110, a transmission configuration associated with a set of transmission occasions. In some aspects, the set of transmission occasions may include a plurality of transmission occasions associated with a plurality of respective resources. In some aspects, the UE 120 may be configured to select k transmission occasions from the N transmission occasions of the set of transmission occasions.

As shown by reference number 810, the UE 120 may hash the data within a message that is to be transmitted to the network node 110, to obtain a hash value of the data within the message. The UE 120 may use the hash value as a seed in a PRNG, where the PRNG is used to select the transmission occasions in which the UE 120 will transmit. As shown by reference number 815, the UE 120 may select the transmission resources based on a reference resource or based on a resource offset applied to the reference resource. In some aspects, the reference resource may be randomly selected. As shown by reference number 820, the UE 120 may transmit multiple copies of a message with each copy of the message including a reference associated with the resource offset.

As shown by reference number 825, after receiving of the set of copies of the message from the UE 120, the network node 110 may decode a copy of the message and the reference associated with the message. As shown by reference number 830, the network node 110 may identify a transmission occasion of each remaining copy of the message based on a PRNG seeded with the hash value generated by hashing the data of the decoded message.

Additionally, the network node 110 may identify the transmission resource of each remaining copy of the message based on a resource offset applied to the transmission resource of the decoded message. In some aspects, only the resources may be identified by the PRNG seeded with the hash value, and the transmission occasions may be signaled by each copy of the message including a reference indicating the transmission occasions of every other copy of the message or one or more copies of the message such that the copies and the references form a strongly connected graph. Alternatively, in some aspects, only the transmission occasions may be identified by the PRNG seeded with the hash value, and the resources may be signaled by each copy of the message including a reference indicating the resource of every other copy of the message or one or more copies of the message such that the copies and the references form a strongly connected graph.

As shown by reference number 835, the network node 110 may perform SIC on the remaining copies of the message that were identified. Accordingly, the network node 110 may remove interference due to the other copies of the message, thereby enabling the decoding of messages from additional UEs 120 that may have collided with the decoded message.

For example, and as described herein, the UE 120 may use the data in a message to be transmitted to obtain a seed that is used to identify k transmission occasions in which to transmit (e.g., o₁, . . . oₖ) and k−1 offsets (e.g., δ₁, . . . δₖ₋₁) in resources across transmission occasions. The UE 120 may randomly select a resource (r₁) for the first transmission occasion in which to transmit. For transmission occasion oᵢ, where i is greater than 1, the UE 120 obtains the resources as (rᵢ₋₁+ δᵢ₋₁) mod l, where l is the number of resources per transmission occasion. In some aspects, the UE 120 may obtain the resources by an invertible function or a similar mathematical operation. After decoding a copy of the message (e.g., in transmission occasion o and resource r), the network node 110 may have the data to obtain the seed and compute o₁, . . . oₖ and δ₁, . . . δₖ₋₁. The network node 110 may identify j such that oⱼ is equal to o and the network node 110 obtains rⱼ=r. The network node may use these identified values in combination with δᵢ to obtain all r₁, . . . rₖ. In some aspects, obtaining the seed that is used to identify transmission occasions in which to transmit can be represented by functions fᵢ(x, Δ) and gᵢ(x, Δ1) such that gᵢ(fᵢ(x, Δ), Δ)=x.

For example, where the number of transmission occasions N=4, the burst size k=3, and the number of available resources l=48, the UE 120 may obtain, from a PRNG, the transmission occasions in which to transmit as o₁=2, o₂=1, and o₃=4. The UE 120 may then obtain, from the PRNG, the resource offsets as δ₁=32 and δ₂=11. The UE 120 may then randomly select r₁=10. The UE 120 may compute r₂=(r₁+ δ₁) mod 48=42 and r₃=(r₂+ δ₂) mod 48=5. As a result, the UE 120 may transmit a first copy of a message in transmission occasion 2 and resource 10, a second copy of the message in transmission occasion 1 and resource 42, and a third copy of the message in transmission occasion 4 and resource 5. Additionally, the network node 110 may first decode a copy of the message in, for example, transmission occasion 1 and resource 42. The network node 110 may identify the transmission occasion and/or resource of each remaining copy of the message using the PRNG seeded with the hash of the data, where o₁=2, o₂=1, and o₃=4, δ₁=32, and δ₂=11. Because o₂ was the transmission occasion of the decoded copy of the message, r₂=42 (e.g., the resource of the transmission occasion decoded). Additionally, r₁ and r₂ may be computed as r₁=(r₂− δ₂) mod 48=10 and r₃=(r₂+ δ₂) mod 48=5.

As described herein, by hashing the data in a copy of the message to enable selection of a transmission occasion via a PRNG and by selecting the transmission resources based on a reference resource or by a resource offset applied to the reference resource, the UE 120 is provided the flexibility to choose the resources in which the UE 120 transmits, as the selection is determined by the data and by a reference resource and resource offset. As a result, the transmission overhead (e.g., transmission data size and/or other similar parameters) may be reduced and the performance of the UE 120 may be improved. For example, the UE 120 may choose resources based on current network conditions or other suitable criteria, as opposed to having the selection determined by the (hashed) data within the message to be transmitted. Additionally, the hash of the data may be sufficiently long to reduce a probability that multiple UEs 120 may generate the same hash value, which would otherwise lead to a potential collision.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with reduced overhead signaling of references.

As shown in FIG. 9, in some aspects, process 900 may include receiving, from a network node, a transmission configuration associated with a set of transmission occasions comprising two or more transmission occasions that are each associated with a set of resources for contention-based transmissions (block 910). For example, the UE (e.g., using reception component 1102 and/or communication manager 1106, depicted in FIG. 11) may receive, from a network node, a transmission configuration associated with a set of transmission occasions comprising two or more transmission occasions that are each associated with a set of resources for contention-based transmissions, as described above.

As further shown in FIG. 9, in some aspects, process 900 may include transmitting, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message (block 920). For example, the UE (e.g., using transmission component 1104 and/or communication manager 1106, depicted in FIG. 11) may transmit, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message, as described above.

Process 900 may include additional aspects, such as any single aspect or any combination of aspects described below and/or in connection with one or more other processes described elsewhere herein.

In a first aspect, the reference indicates at least one of a transmission occasion or a resource associated with each copy of the message.

In a second aspect, alone or in combination with the first aspect, the reference indicates at least one of a transmission occasion or a resource associated with a subset of the plurality of copies of the message.

In a third aspect, alone or in combination with one or more of the first and second aspects, process 900 includes selecting at least one of the resource or the plurality of transmission occasions based on a pseudo random number generator that is seeded with a reference value associated with the reference.

In a fourth aspect, alone or in combination with one or more of the first through third aspects, the reference value is randomly generated.

In a fifth aspect, alone or in combination with one or more of the first through fourth aspects, the reference value is a function of a random access occasion group number or a radio frame number associated with the plurality of copies of the message.

In a sixth aspect, alone or in combination with one or more of the first through fifth aspects, the reference value is based on a hash value of data within the plurality of copies of the message.

In a seventh aspect, alone or in combination with one or more of the first through sixth aspects, process 900 includes generating a seed value based on a hash value of data within the plurality of messages, generating a resource offset based on a PRNG that is seeded with the seed value, and selecting either the plurality of transmission occasions or the resource associated with each copy of the message according to a randomly-generated reference resource or according to the resource offset applied to the randomly-generated reference resource.

In an eighth aspect, alone or in combination with one or more of the first through seventh aspects, process 900 includes generating a seed value based on a hash value of data within the plurality of messages, selecting at least one of the resource or the plurality of transmission occasions based on a PRNG that is seeded with the seed value, and generating a resource offset based on the PRNG that is seeded with the seed value, and selecting the resource associated with each copy of the message according to a randomly-generated reference resource or according to the resource offset applied to the randomly-generated reference resource.

In a ninth aspect, alone or in combination with one or more of the first through eight aspects, the selected resource includes at least one of a time resource, a frequency resource, an orthogonal cover code associated with the transmission.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with reduced overhead signaling of references for resolving collisions.

As shown in FIG. 10, in some aspects, process 1000 may include receiving, from a UE, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message (block 1010). For example, the network node (e.g., using reception component 1202 and/or communication manager 1206, depicted in FIG. 12) may receive, from a UE, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message, as described above.

As further shown in FIG. 10, in some aspects, process 1000 may include decoding a copy of the message and the reference included with the copy of the message (block 1020). For example, the network node (e.g., using communication manager 1206, depicted in FIG. 12) may decode a copy of the message and the reference included with the copy of the message, as described above.

As further shown in FIG. 10, in some aspects, process 1000 may include identifying a transmission occasion of each remaining copy of the message based on the decoded reference associated with the decoded copy of the message (block 1030). For example, the network node (e.g., using communication manager 1206, depicted in FIG. 12) may identify a transmission occasion of each remaining copy of the message based on the decoded reference associated with the decoded copy of the message, as described above.

As further shown in FIG. 10, in some aspects, process 1000 may include performing SIC on the remaining copies of the message based on the decoded copy of the message (block 1040). For example, the network node (e.g., using communication manager 1206, depicted in FIG. 12) may perform SIC on the remaining copies of the message based on the decoded copy of the message, as described above.

Process 1000 may include additional aspects, such as any single aspect or any combination of aspects described below and/or in connection with one or more other processes described elsewhere herein.

In a first aspect, the reference indicates at least one of a transmission occasion or a resource associated with each copy of the message.

In a second aspect, alone or in combination with the first aspect, the decoded reference indicates at least one of a transmission occasion or a resource associated with a subset of the plurality of copies of the message.

In a third aspect, alone or in combination with one or more of the first and second aspects, the plurality of transmission occasions are identified based on a PRNG that is seeded with a reference value associated with the decoded reference.

In a fourth aspect, alone or in combination with one or more of the first through third aspects, the reference value is a function of a random access occasion group number or a radio frame number associated with the plurality of copies of the message.

In a fifth aspect, alone or in combination with one or more of the first through fourth aspects, the reference value is associated with a hash value generated based on data within the decoded copy of the message.

In a sixth aspect, alone or in combination with one or more of the first through fifth aspects, process 1000 includes hashing data within the decoded copy of the message to obtain a seed value, and identifying one or more of the plurality of transmission occasions or the resources associated with the plurality of copies of the message based on a pseudo random number generator that is seeded with the seed value.

In a seventh aspect, alone or in combination with one or more of the first through sixth aspects, the selected resource includes at least one of a time resource, a frequency resource, an orthogonal cover code associated with the transmission.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node, a transmission configuration associated with a set of transmission occasions comprising two or more transmission occasions that are each associated with a set of resources for contention-based transmissions. The transmission component 1104 may transmit, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a UE, a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message. The communication manager 1206 may decode a copy of the message and the reference included with the copy of the message. The communication manager 1206 may identify a transmission occasion of each remaining copy of the message based on the decoded reference associated with the decoded copy of the message. The communication manager 1206 may perform SIC on the remaining copies of the message based on the decoded copy of the message.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a network node, a transmission configuration associated with a set of transmission occasions comprising two or more transmission occasions that are each associated with a set of resources for contention-based transmissions; and transmitting, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message.

Aspect 2: The method of Aspect 1, wherein the reference indicates at least one of a transmission occasion or a resource associated with each copy of the message.

Aspect 3: The method of any of Aspects 1-2, wherein the reference indicates at least one of a transmission occasion or a resource associated with a subset of the plurality of copies of the message.

Aspect 4: The method of any of Aspects 1-3, further comprising: selecting at least one of the resource or the plurality of transmission occasions based on a pseudo random number generator that is seeded with a reference value associated with the reference.

Aspect 5: The method of Aspect 4, wherein the reference value is randomly generated.

Aspect 6: The method of Aspect 4, the reference value is a function of a random access occasion group number or a radio frame number associated with the plurality of copies of the message.

Aspect 7: The method of Aspect 4, wherein the reference value is based on a hash value of data within the plurality of copies of the message.

Aspect 8: The method of any of Aspects 1-7, further comprising: generating a seed value based on a hash value of data within the plurality of messages; generating a resource offset based on a pseudo random number generator (PRNG) that is seeded with the seed value; and selecting either the plurality of transmission occasions or the resource associated with each copy of the message according to a randomly-generated reference resource or according to the resource offset applied to the randomly-generated reference resource.

Aspect 9: The method of Aspect 8, further comprising: generating a seed value based on a hash value of data within the plurality of messages; selecting at least one of the resource or the plurality of transmission occasions based on a pseudo random number generator (PRNG) that is seeded with the seed value; generating a resource offset based on the PRNG that is seeded with the seed value; and selecting the resource associated with each copy of the message according to a randomly-generated reference resource or according to the resource offset applied to the randomly-generated reference resource.

Aspect 10: The method of any of Aspects 1-9, wherein the selected resource includes at least one of a time resource, a frequency resource, an orthogonal cover code associated with the transmission.

Aspect 11: A method of wireless communication performed by a network node, comprising: receiving, from a user equipment (UE), a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message; decoding a copy of the message and the reference included with the copy of the message; identifying a transmission occasion of each remaining copy of the message based on the decoded reference associated with the decoded copy of the message; and performing successive interference cancellation on the remaining copies of the message based on the decoded copy of the message.

Aspect 12: The method of Aspect 11, wherein the reference indicates at least one of a transmission occasion or a resource associated with each copy of the message.

Aspect 13: The method of any of Aspects 11-12, wherein the decoded reference indicates at least one of a transmission occasion or a resource associated with a subset of the plurality of copies of the message.

Aspect 14: The method of any of Aspects 11-13, wherein the plurality of transmission occasions are identified based on a pseudo random number generator that is seeded with a reference value associated with the decoded reference.

Aspect 15: The method of Aspect 14, wherein the reference value is a function of a random access occasion group number or a radio frame number associated with the plurality of copies of the message.

Aspect 16: The method of Aspect 14, wherein the reference value is associated with a hash value generated based on data within the decoded copy of the message.

Aspect 17: The method of any of Aspects 11-16, further comprising: hashing data within the decoded copy of the message to obtain a seed value; and identifying one or more of the plurality of transmission occasions or the resources associated with the plurality of copies of the message based on a pseudo random number generator that is seeded with the seed value.

Aspect 17: The method of any of Aspects 11-17, wherein the selected resource includes at least one of a time resource, a frequency resource, an orthogonal cover code.

Aspect 18: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-17.

Aspect 19: An apparatus for wireless communication at a device, the apparatus comprising one or more memories and one or more processors coupled to the one or more memories, the one or more processors configured to cause the device to perform the method of one or more of Aspects 1-17.

Aspect 20: An apparatus for wireless communication, the apparatus comprising at least one means for performing the method of one or more of Aspects 1-17.

Aspect 21: A non-transitory computer-readable medium storing code for wireless communication, the code comprising instructions executable by one or more processors to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

Aspect 23: A device for wireless communication, the device comprising a processing system that includes one or more processors and one or more memories coupled with the one or more processors, the processing system configured to cause the device to perform the method of one or more of Aspects 1-17.

Aspect 24: An apparatus for wireless communication at a device, the apparatus comprising one or more memories and one or more processors coupled to the one or more memories, the one or more processors individually or collectively configured to cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, a transmission configuration associated with a set of transmission occasions comprising two or more transmission occasions that are each associated with a set of resources for contention-based transmissions; and
transmit, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message.

2. The UE of claim 1, wherein the reference indicates at least one of a transmission occasion or a resource associated with each copy of the message.

3. The UE of claim 1, wherein the reference indicates at least one of a transmission occasion or a resource associated with a subset of the plurality of copies of the message.

4. The UE of claim 1, wherein the one or more processors further cause the UE to:
select at least one of the resource or the plurality of transmission occasions based on a pseudo random number generator that is seeded with a reference value associated with the reference.

5. The UE of claim 4, wherein the reference value is a function of a random access occasion group number or a radio frame number associated with the plurality of copies of the message.

6. The UE of claim 4, wherein the reference value is based on a hash value of data within the plurality of copies of the message.

7. The UE of claim 1, wherein the one or more processors further cause the UE to:
generate a seed value based on a hash value of data within the plurality of messages;
generate a resource offset based on a pseudo random number generator (PRNG) that is seeded with the seed value; and
select either the plurality of transmission occasions or the resource associated with each copy of the message according to a randomly-generated reference resource or according to the resource offset applied to the randomly-generated reference resource.

8. The UE of claim 1, wherein the one or more processors further cause the UE to:
generate a seed value based on a hash value of data within the plurality of messages;
select the plurality of transmission occasions based on a pseudo random number generator (PRNG) that is seeded with the seed value;
generate a resource offset based on the PRNG that is seeded with the seed value; and
select the resource associated with each copy of the message according to a randomly-generated reference resource or according to the resource offset applied to the randomly-generated reference resource.

9. A network node for wireless communication, comprising:
one or more memories; and
one or more processors, coupled to the one or more memories, configured to cause the network node to:
receive, from a user equipment (UE), a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message;
decode a copy of the message and the reference included with the copy of the message;
identify a transmission occasion of each remaining copy of the message based on the decoded reference associated with the decoded copy of the message; and
perform signal interference cancellation on the remaining copies of the message based on the decoded copy of the message.

10. The network node of claim 9, wherein the reference indicates at least one of a transmission occasion or a resource associated with each copy of the message.

11. The network node of claim 9, wherein the decoded reference indicates at least one of a transmission occasion or a resource associated with a subset of the plurality of copies of the message.

12. The network node of claim 9, wherein at least one of the resource or the plurality of transmission occasions are identified based on a pseudo random number generator that is seeded with a reference value associated with the decoded reference.

13. The network node of claim 12, wherein the reference value is a function of a random access occasion group number or a radio frame number associated with the plurality of copies of the message.

14. The network node of claim 12, wherein the reference value is associated with a hash value generated based on data within the decoded copy of the message.

15. The network node of claim 9, wherein the one or more processors are further configured to cause the network node to:
hash data within the decoded copy of the message to obtain a seed value; and
identify one or more of the plurality of transmission occasions or the resources associated with the plurality of copies of the message based on a pseudo random number generator that is seeded with the seed value.

16. A method of wireless communication performed by a user equipment (UE), comprising:
receiving, from a network node, a transmission configuration associated with a set of transmission occasions comprising two or more transmission occasions that are each associated with a set of resources for contention-based transmissions; and
transmitting, to the network node, a plurality of copies of a message in a plurality of transmission occasions selected from the set of transmission occasions, wherein each copy of the message is transmitted in a resource selected from the set of resources, and wherein each copy of the message includes a reference associated with one or more other copies of the message.

17. The method of claim 16, wherein the reference indicates at least one of a transmission occasion or a resource associated with each copy of the message.

18. The method of claim 16, wherein the reference indicates at least one of a transmission occasion or a resource associated with a subset of the plurality of copies of the message.

19. The method of claim 16, further comprising:
selecting at least one of the resource or the plurality of transmission occasions based on a pseudo random number generator that is seeded with a reference value associated with the reference.

20. The method of claim 19, wherein the reference value is randomly generated.

21. The method of claim 19, wherein the reference value is a function of a random access occasion group number or a radio frame number associated with the plurality of copies of the message.

22. The method of claim 19, wherein the reference value is based on a hash value of data within the message.

23. The method of claim 16, further comprising:
generating a seed value based on a hash value of data within the plurality of messages;
generating a resource offset based on a pseudo random number generator (PRNG) that is seeded with the seed value; and
selecting either the plurality of transmission occasions or the resource associated with each copy of the message according to a randomly-generated reference resource or according to the resource offset applied to the randomly-generated reference resource.

24. The method of claim 16, wherein the selected resource includes at least one of a time resource, a frequency resource, or an orthogonal cover code associated with the transmission.

25. A method of wireless communication performed by a network node, comprising:
receiving, from a user equipment (UE), a plurality of copies of a message in a plurality of transmission occasions selected from a set of transmission occasions comprising two or more transmission occasions that are each associated with a set of resources for contention-based transmissions, wherein each copy of the message is transmitted in a resource selected from a set of resources for contention-based transmissions, and wherein each copy of the message includes a reference associated with one or more other copies of the message;
decoding a copy of the message and the reference included with the copy of the message;
identifying a transmission occasion of each remaining copy of the message based on the decoded reference associated with the decoded copy of the message; and
performing successive interference cancellation on the remaining copies of the message based on the decoded copy of the message.

26. The method of claim 25, wherein the reference indicates at least one of a transmission occasion or a resource associated with each copy of the message.

27. The method of claim 25, wherein the decoded reference indicates at least one of a transmission occasion or a resource associated with a subset of the plurality of copies of the message.

28. The method of claim 25, wherein the plurality of transmission occasions are identified based on a pseudo random number generator that is seeded with a reference value associated with the decoded reference.

29. The method of claim 28, wherein the reference value is a function of a random access occasion group number or a radio frame number associated with the plurality of copies of the message.

30. The method of claim 28, wherein the reference value is associated with a hash value generated based on data within the decoded copy of the message.
